(19) United States
(12) Patent Application Publication
(10) Pub. No.: US 2007/0268483 A1
(43) Pub. Date: Nov. 22, 2007

(54) Inspection apparatus for image pickup device, optical inspection unit device, and optical inspection unit

(75) Inventors: Yasuo Yatsugake, Kodama-gun (JP); Yoshitsugu Taniguchi, Kumamoto-shi (JP)

Correspondence Address: JORDAN AND HAMBURG LLP, 122 EAST 42ND STREET, SUITE 4000, NEW YORK, NY, 10168, US

(73) Assignee: AITOS INC., Joyo-shi (JP)

(21) Appl. No.: 11/484,993

(22) Filed: Jul. 12, 2006

(30) Foreign Application Priority Data
May 18, 2006 (JP) 2006-138438

(51) Int. Cl. G01N 21/00

(52) U.S. Cl. 356/237.1

(57) ABSTRACT

A probe card is equipped with a plurality of openings that transmit light to an image pickup device. An optical inspection unit that emits a test light through the plurality of openings of the probe card while being arranged in opposition to a light receiving portion of the image pickup device, a holding means that simultaneously positions and holds a plurality of optical inspection units, and an individual adjustment means that makes a converting adjustment carried out, for light from a light irradiator corresponding to the image pickup device, so as to match the same with specifications of the image pickup device be individually carried out for each optical inspection unit are provided. By replacing or adjusting each optical inspection unit while making the same attachable and detachable, an optical axis adjustment can be easily carried out, and the cost can be reduced.

### BACKGROUND OF THE INVENTION

1. Field of the Invention

The present invention relates to an inspection unit device, an inspection apparatus, and an optical inspection unit for a solid-state image pickup device such as a CCD image sensor, a CMOS image sensor, or the like.

2. Description of the Prior Art

Recently, with the increase in the number of pixels owing to an improvement in integration density of a solid-state image pickup device (image sensor) such as a CCD (Charge Coupled Device), a CMOS (Complementary Metal Oxide Semiconductor), or the like, the angle (angle of incidence or angle of view) of light made incident into the image sensor has increased. For this reason, a difference in quantity of light made incident into photodiodes occurs between the center part and peripheral part of the solid-state image pickup device, and shading for which the peripheral part is darkened increases. As a method for coping with the phenomenon, a pupil correction to secure light quantity in the peripheral part of pixels by correcting the position of microlenses present on the photodiodes exists. In the pupil correction, from the center to the periphery of the angle of view, by giving an offset to the optical axis of the microlens and the opening center of the photodiode little by little, a so-called eclipse phenomenon is reduced so that a more uniform sensitivity can be obtained even when a small-sized lens with a short exit pupil distance is used as in, for example, a mobile phone or a small-sized digital camera. In inspecting photoelectric conversion characteristics of the solid-state image pickup device performed with a pupil correction as such, if a telecentric light of a light irradiator for inspection is made incident into the solid-state image pickup device, the pupil correction adversely effects, and light quantity in the periphery of a light receiving unit of the image pickup device further declines. Therefore, in the light irradiator, an optical system of an imaging system is inserted after the telecentric light and immediately before being irradiated onto the image pickup device applied with a pupil correction so as to irradiate a light aligned with the pupil position of the solid-state image pickup device.

Conventionally, with regard to the inspection of photoelectric conversion characteristics of an image pickup device loaded with on-chip microlenses as described above, a device described in Patent Document 1 (Japanese Published Unexamined Patent Application No. 2005-175363) has been proposed.

### [Patent Document 1] Japanese Published Unexamined Patent Application No. 2005-175363

The invention according to Patent Document 1 discloses an image pickup device inspection apparatus including an illuminating device that illuminates image pickup devices, a prober that takes out output from the image pickup devices, and a tester, wherein an optical adapter is attached to the outside of the illuminating device, and a light flux emitted from the illuminating device is converted by the optical adapter to one that meets conditions of the image pickup devices. Therein, since the optical adapter being a pupil inspection optical system has been attached to the illuminating device side, it has been necessary to support the optical adapter on the illuminating device side via a driving arm or the like and carry out an optical axis adjustment of a probe card and the pupil inspection optical system while adjusting the optical adapter by shifting, if necessary, for example. Therefore, not only does an alignment operation including adjustment of a drive portion to make it possible to securely maintain an optical axis position after shifting take time, but also a high-precision mechanism is required for a drive system, and furthermore, a new optical axis adjustment is necessary after every maintenance so that there has been a problem in inferiority in inspection efficiency. Moreover, since an alignment mechanism between the optical adapter and probe card is greater in size than the image pickup devices with a small area, it has been difficult to carry out inspection efficiently and consecutively while shifting along adjacent lines or rows of the image pickup devices integrally formed on a wafer, and the inspection has often been carried out for every other device or while shifting in an oblique direction (see FIG. 9). Furthermore, there have been no standards between the probe card and pupil inspection optical system, it has been necessary to fabricate a probe card matched with an optical system or an optical system matched with a probe card every time, so that there has been a problem in a high inspection cost.

### SUMMARY OF THE INVENTION

The present invention has been made in view of the conventional problems as described above, and it is an object thereof, by holding a plurality of optical inspection units in a manner positioned in a plurality of openings of a probe card by a holding means, and furthermore, allowing a pupil distance adjustment for each of the inspection units, to provide an inspection apparatus for an image pickup device, an optical inspection unit device, and an optical inspection unit that can simply carry out alignment between the optical inspection units and probe card in a short time, for which the configuration of a holding portion of the optical inspection units is reduced in size, and that are capable of carrying out an efficient and consecutive light irradiation. In addition, another object of the present invention is to provide an inspection apparatus for an image pickup device, an optical inspection unit device, and an optical inspection unit that can reduce the inspection cost, without newly fabricating an optical system, by merely adjusting or replacing only the optical inspection units so as to match new image pickup devices even when the image pickup devices being an inspection target change in size while a structure for which a probe card and a holding portion are integrated is used in common.

In order to achieve the object, according to the present invention, an optical inspection unit device that irradiates a test light, in a photoelectric conversion characteristic inspection of an image pickup device, while being arranged in opposition to a light receiving portion of the image pickup device is provided. The optical inspection unit device is constructed as an optical inspection unit device 52 that includes: a probe card 501 that retains a probe pin 502 to take out output from an output terminal portion 1y of an image pickup device 1 and is equipped with a plurality of openings 501a that transmit light to the image pickup device 1; an optical inspection unit 520 that irradiates the test light through the plurality of openings of the probe card while being arranged in opposition to the light receiving portion (1A) of the image pickup device; a holding means 504 that simultaneously positions and holds a plurality of optical inspection units while arranging an emission side of the optical inspection unit 520 in opposition to the light receiving portion of the image pickup device with an optical axis C of the optical inspection unit being aligned on the light receiving surface of the image pickup device 1; and an individual adjustment means 505 that makes a converting adjustment carried out, for light from a light irradiator corresponding to the image pickup device being an inspection target, so as to match the same with specifications of the image pickup device be individually carried out for each optical inspection unit. By making only the optical inspection units 520 attachable and detachable, respectively, with the optical axes being determined and aligned by the holding means, only the optical inspection units 520 are changed without basically changing the probe card and holding means even in a case where a chip being an inspection object is different in size or the like, whereby reduction in manufacturing cost, reduction in inspection preparation time, maintainability, and the like can be secured.

At this time, it is preferable that the optical inspection unit 520 is formed of a case body having a built-in optical lens 522, and the individual adjustment means 505 makes the case body attachable and detachable with respect to the holding means 504.

In addition, it is preferable that the individual adjustment means 505 includes a shifting adjustment mechanism 553 for an engagement position between the optical inspection unit 520 and holding means 504 so as to make the whole optical inspection unit 520 shiftable in an optical axis C direction, and the converting adjustment to match light from a light irradiator with specifications of the image pickup device 1 is carried out by a shifting adjustment of the engagement position by the shifting adjustment mechanism. If a pupil distance adjustment is possible by merely changing the relative position of the optical inspection unit with respect to the holding means, an individual converting adjustment can be carried out by an extremely simple method.

In addition, it is preferable that the case body has a plurality of built-in optical lenses 522, and the individual adjustment means 505 includes an axial position adjustment mechanism 530 that sets an optical-axis-direction position of the plurality of optical lenses in the case body so as to be changeable. In this case, replacement of the case body itself is unnecessary, and a converting adjustment that is carried out, for light from a light irradiator corresponding to the solid-state image pickup device, so as to match the same with specifications of the image pickup device can be carried out at a low cost by only a position adjustment of the internal optical lenses or a lens replacement according to necessity.

In addition, it is preferable that the optical inspection unit 520 is formed of a barrel long in one direction.

In addition, it is preferable that the holding means 504 is formed of a mount mechanism 506 that allows to insertably and removably mount the optical inspection unit 520 in cooperation with the probe card 501 and allows to hold the optical inspection unit 520, when mounted, with an optical axis thereof being aligned on the light receiving surface of the image pickup device.

At this time, it is preferable that the mount mechanism 506 is formed of one or a plurality of supporting mounts 507 having a through-hole 509 that supports the optical inspection unit 520 in a manner penetrating therethrough.

In addition, it is preferable that the probe pin 501 is formed of a vertical pin that almost vertically abuts against the light receiving portion of the image pickup device 1.

Furthermore, it is preferable that the optical inspection unit device by the mount mechanism 506 simultaneously holds a plurality of optical inspection units 520 at holding positions in a lengthwise and widthwise matrix coincident with a formation spacing of the image pickup devices 1 installed in a matrix.

Moreover, according to the present invention, it is preferable that an optical inspection unit that irradiates a test light, in a photoelectric conversion characteristic inspection of an image pickup device, while being arranged in opposition to a light receiving portion of the image pickup device is attachably and detachably held by a holding means 504 installed in the vicinity of a probe card 501 having a plurality of openings 501a, is held, when mounted, with an optical axis C thereof being aligned on a light receiving surface of the image pickup device irradiated through the opening 501a, and furthermore, carries out, by means of an individual adjustment means 505, a converting adjustment to match light from a light irradiator 12 corresponding to the image pickup device being an inspection target with specifications of the image pickup device 1 for each optical inspection unit 520 individually.

At this time, it is preferable that the optical inspection unit 520 is formed of a case body having a built-in optical lens 522, and the case body is made attachable and detachable with respect to the holding means.

In addition, it is preferable to provide a shifting adjustment mechanism for an engagement position between the optical inspection unit and holding means so as to make the whole optical inspection unit shiftable in an optical axis direction.

In addition, it may be preferable that the case body has a plurality of built-in optical lenses 522, and an axial position adjustment mechanism 530 that sets an optical-axis-direction position of the plurality of optical lenses in the case body so as to be changeable is included.

In addition, it is more preferable that the optical inspection unit is formed of a barrel long in one direction.

Moreover, according to the present invention, an inspection apparatus for an image pickup device that irradiates a test light L onto an image pickup device 1 to inspect photoelectric conversion characteristics of the image pickup device is provided. The inspection apparatus for an image pickup device is constructed as an inspection apparatus 10 for an image pickup device that has an optical inspection unit device 50 that irradiates a test light while being arranged in opposition to a light receiving portion of the image pickup device 1, and the optical inspection unit device includes: a probe card 501 that retains a probe pin 502 to take out output from an output terminal portion 1y of the image pickup device 1 and is equipped with a plurality of openings 501a that transmit light to the image pickup device 1; an optical inspection unit 520 that irradiates the test light through the plurality of openings 501a of the probe card 501 while being arranged in opposition to the light receiving portion of the image pickup device 1; a holding means 504 that simultaneously positions and holds a plurality of optical inspection units while arranging an emission side of the optical inspection unit 520 in opposition to the light receiving portion of the image pickup device 1 with an optical axis C of the optical inspection unit being aligned on the light receiving surface of the image pickup device 1; and an individual adjustment means 505 that makes a converting adjustment carried out, for light from a light irradiator corresponding to the image pickup device being an inspection target, so as to match the same with specifications of the image pickup device be individually carried out for each optical inspection unit.

In addition, in the inspection apparatus for an image pickup device, it is preferable that the optical inspection unit 520 is formed of a case body having a built-in optical lens 522, and the individual adjustment means 505 makes the case body attachable and detachable with respect to the holding means 504.

In addition, in the inspection apparatus for an image pickup device, it is preferable that the individual adjustment means includes a shifting adjustment mechanism for an engagement position between the optical inspection unit and holding means so as to make the whole optical inspection unit shiftable in an optical axis direction, and the converting adjustment to match light from a light irradiator with specifications of the image pickup device is carried out by a shifting adjustment of the engagement position by the shifting adjustment mechanism.

In addition, in the inspection apparatus for an image pickup device, it is preferable that the case body has a plurality of built-in optical lenses, and the individual adjustment means includes an axial position adjustment mechanism that sets an optical-axis-direction position of the plurality of optical lenses so as to be changeable.

Furthermore, in the inspection apparatus for an image pickup device, it may be preferable that the optical inspection unit is formed of a barrel long in one direction.

Moreover, in the inspection apparatus for an image pickup device, the holding means is formed of a mount mechanism that allows to insertably and removably mount the optical inspection unit while being coupled with the probe card and allows to hold the optical inspection unit, when mounted, with an optical axis thereof being aligned on the light receiving surface of the image pickup device.

In addition, it may be preferable that the mount mechanism is formed of one or a plurality of supporting mounts having a through-hole that supports the optical inspection unit in a manner penetrating therethrough.

In addition, it is preferable that the probe pin is formed of a vertical pin that almost vertically abuts against the light receiving portion of the image pickup device.

Furthermore, it is more preferable that the optical inspection unit device by the mount mechanism simultaneously holds a plurality of optical inspection units at holding positions in a lengthwise and widthwise matrix coincident with a formation spacing of the image pickup devices installed in a matrix.

### BRIEF DESCRIPTION OF THE DRAWINGS

FIG. 1 is a schematic explanatory view of an inspection apparatus for an image pickup device including an optical inspection unit device and optical inspection units according to an embodiment of the present invention;

FIG. 2 is an enlarged perspective view of the optical inspection unit device of the inspection apparatus of FIG. 1;

FIG. 3 is a main-part enlarged partially sectional explanatory view of FIG. 1;

FIG. 4 is an overall perspective explanatory view of only an optical inspection unit part in FIG. 2;

FIG. 5 is a partially omitted enlarged sectional explanatory view of the optical inspection unit of FIG. 3;

FIG. 6A is a longitudinal sectional view of one optical inspection unit;

FIG. 6B is a partially omitted longitudinal sectional view showing another embodiment for a pupil position adjustment of the optical inspection unit;

FIG. 7 is an explanatory view showing a construction of a spacing adjustment in an optical axis direction of optical lenses by spacers;

FIG. 8 is a view showing a simultaneous inspection target of solid-state image pickup devices by an optical inspection unit device of the present invention; and

FIG. 9 is a view showing a virtual simultaneous inspection target of solid-state image pickup devices in a conventional probe pin construction as a comparative example.

### DETAILED DESCRIPTION OF THE PREFERRED EMBODIMENTS

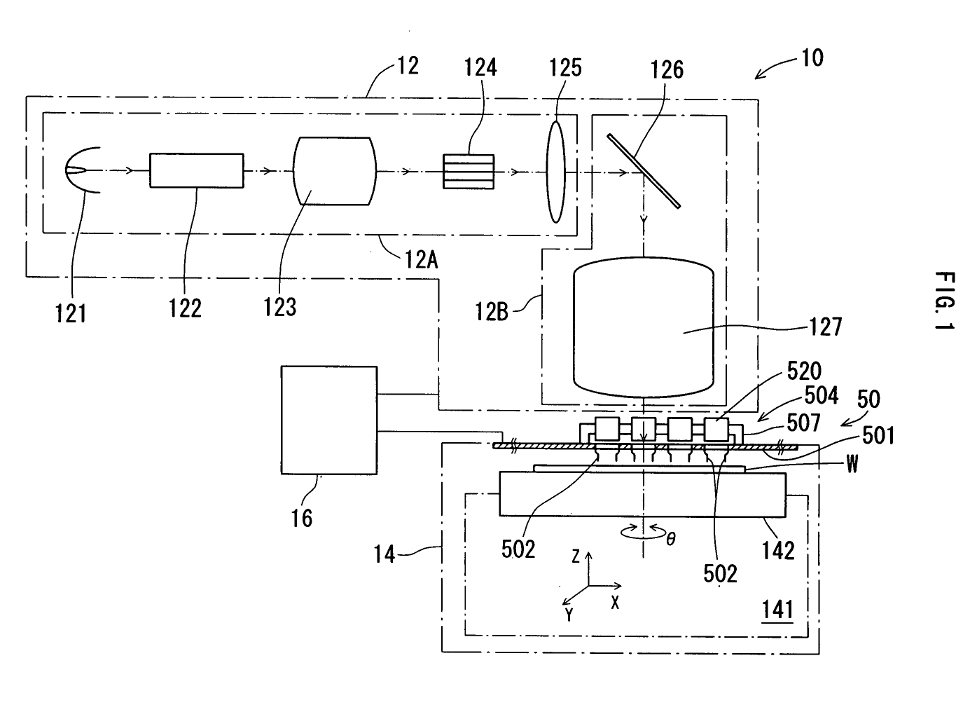

Hereinafter, embodiments of the present invention will be described with reference to the accompanying drawings. FIG. 1 to FIG. 8 show embodiments of an optical unit device, an optical unit, and an inspection apparatus for an image pickup device, of which FIG. 1 is a schematic configuration view of the inspection apparatus for an image pickup device. An inspection apparatus 10 for an image pickup device of the embodiment includes a light irradiator 12, a prober 14, a tester 16, and an optical inspection unit device 50.

In the present embodiment, the light irradiator 12 is a light irradiating means used in, for example, an inspection of photoelectric conversion characteristics of a solid-state image pickup device such as a CCD or a CMOS, for irradiating light onto a light receiving surface of the solid-state image pickup device and has a parallel light generating portion 12A and an irradiating introductory portion 12B. In the present embodiment, the parallel light generating portion 12A includes a light source 121, a homogenizer 122, a collector lens 123, a fly-eye lens 124, and a connection lens 125. For the light source 121, a halogen lamp, a xenon lamp, a metal halide lamp, an LED, or the like is used. Then, light emitted from the light source is split and adjusted in quantity by an unillustrated color filter, color-temperature filter, ND filter, wedge filter, or the like, and an illumination distribution of the light adjusted in quantity is uniformized via the homogenizer 122, collector lens 123, and fly-eye lens 124. A light flux exited from the fly-eye lens 124 is emitted to the irradiating introductory portion 12B via the connection lens 125. The irradiating introductory portion 12B has a function, when irradiating the light flux adjusted in quantity and illumination onto the image pickup devices on a wafer being an inspection target, to emit the same as a wide parallel light on the wafer side, and in the present embodiment, the irradiating introductory portion 12B includes a reflecting mirror 126 and a projection lens 127. For the projection lens 127, for example, used is a Koehler type illumination lens, which emits a parallel light L. The emitted parallel light L is irradiated onto the light receiving surface of the image pickup device via the optical inspection unit device 50.

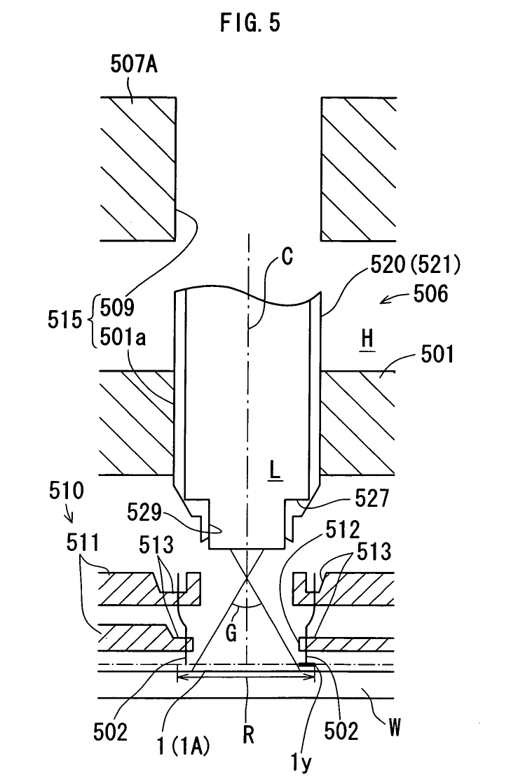

The prober 14 includes a transfer positioning device 141 on which a wafer W having solid-state image pickup devices 1 being an inspection target formed in a matrix is placed for transfer positioning and a probe card 501 that supports probe pins 502 to receive electrical signals outputted from the image pickup devices. As is also shown in FIG. 5, the probe pin 502 takes out output from an output terminal portion 1y, that is, a pad portion, of the solid-state image pickup device to be inspected and supplies an electrical signal to the tester 16. The transfer positioning device 141 includes a shifting stage 142 that is transfer-driven in X, Y, and Z directions (see FIG. 1) via an unillustrated driving device and positioning device, respectively and freely transfer-positions the wafer W on which CCD or CMOS image pickup devices to be inspected have been formed within a case cover. The shifting stage 142 is also rotary-driven in a θ direction of FIG. 1. In the present embodiment, the probe card 501 is arranged on a top board or upper end side of the case cover of the prober 14 and is fixed to the prober 14. The probe card 501 has probe pins 502 that contact with pads of the solid-state image pickup devices 1 and electrically connects the tester 16 with the solid-state image pickup devices 1.

The tester 16 has an unillustrated test head, includes a power supply applied to the solid-state image pickup devices 1 through the probe card 501, various signal generating portions such as a timing generator and a pattern generator, an input portion that obtains electrical signals from the solid-state image pickup device measured through the probe card 501, and the like, and receives the electrical signals outputted by the solid-state image pickup devices so as to inspect characteristics of the devices.

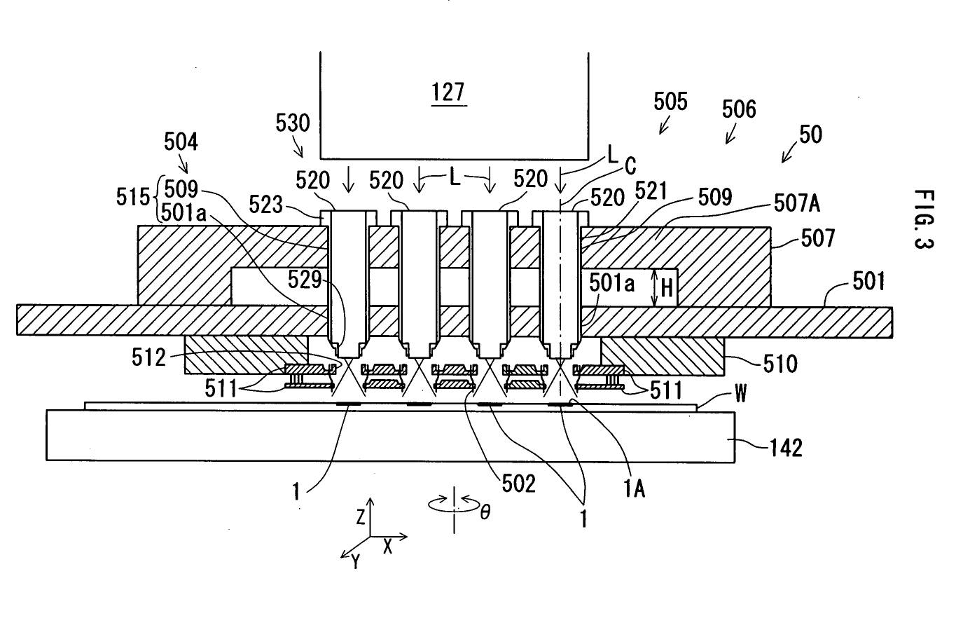

The optical inspection unit device 50 is one characteristic construction of the present invention, and this converts a parallel light from the light irradiator 12 to such a light that can carry out a proper inspection of photoelectric conversion characteristics for pupil-corrected solid-state image pickup devices and irradiates the same onto the solid-state image pickup devices. In the implementation of FIG. 1 and FIG. 3, the optical inspection unit device 50 includes the probe card 501, optical inspection units 520, a holding means 504, and an individual adjustment means 505. As described above, the pupil-corrected solid-state image pickup devices are attached and covered with unillustrated microlenses.

The optical inspection unit device 50 attaches the holding means 504 to the probe card 501 fixed to the prober 14 and simultaneously holds a plurality of optical inspection units 520 while making a plurality of optical inspection units attachable and detachable with respect to the holding means 504 so as to hold and position the optical inspection units and makes it possible to individually adjust the angle of view and pupil distance of each image pickup device by a light irradiation for each optical inspection unit.

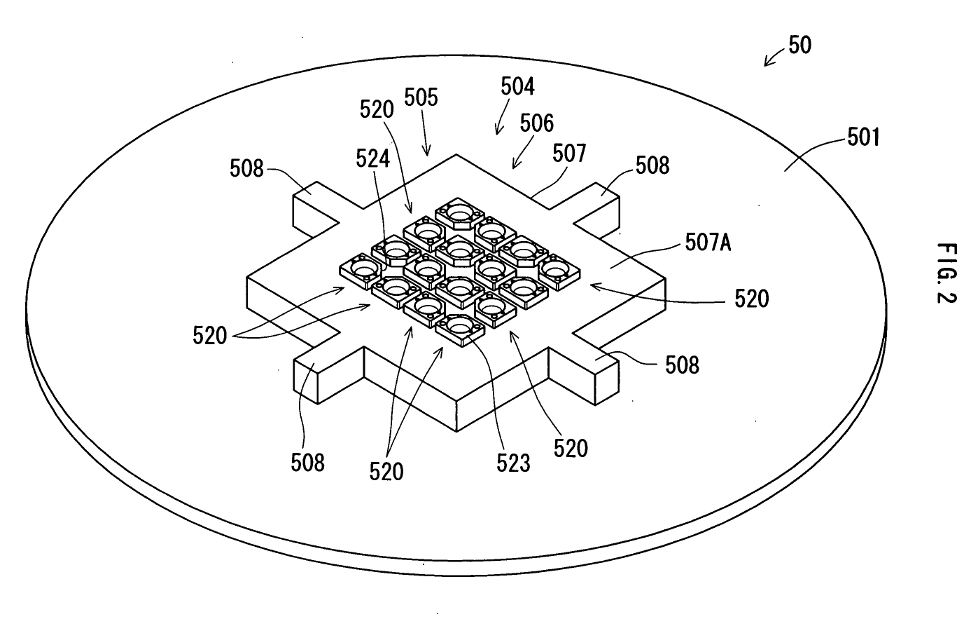

In FIG. 1 and FIG. 3, on the probe card 501, in a manner corresponding to an arrangement of the optical inspection units 520 of FIG. 2, a total of 16 positioning through-holes 501a are formed lengthwise and widthwise in a 4 by 4 equally spaced matrix, and these form a part of the individual adjustment means 505 and a mount mechanism 506. At the upper side corresponding to the position to form the positioning through-holes 501a, a supporting mount 507 as also shown in FIG. 2 is arranged so as to cover the 16 through-holes, and this is fixed to the upper surface of the probe card 501 at attaching portions 508 by fixing means such as setscrews (unillustrated). The supporting mount 507 is made of a plate-like body whose main component is an upper plate portion 507A being a square plate in the embodiment and in which a concave portion is provided so as to form a hollow H on the lower surface side, and the four attaching portions 508 are formed so as to protrude to the outside from center portions of the respective sides. Then, the upper plate portion 507A is arranged so as to have the hollow H between the same and the upper surface of the probe card 501, and on the upper plate portion 507A, 16 upper through-holes 509 are formed in a matrix. The upper through-holes 509 are provided at positions that respectively vertically correspond to the through-holes 501a, respectively. Furthermore, on the lower surface side of the probe card 501, a frame-shaped lower mount 510 is attached, and on the lower mount 510, pin retainer plates 511 are fixed and supported at a position leveled down from the probe card 501. On the pin retainer plates 511 as well, similar to the probe card 501 and upper plate portion 507A, holes 512 are formed in an equally spaced lengthwise and widthwise matrix, respectively, and these through-holes 501a, 509, and 512 of the probe card 501, upper plate portion 507A, and pin retainer plates 511 are fixed in a centered condition so that center axes, that is, optical axes through which light passes are made coincident. In the embodiment, the pin retainer plates 511 are made of two ceramic plates coupled in a layer form with a parallel gap formed therebetween, and the probe pins 502 are attached and fixed to the pin retainer plates 511. In the present embodiment, the mount mechanism 506 includes the supporting mount 507 having the upper through-holes and probe card 501 having the through-holes 501a. The mount mechanism 506 is a holding means that allows to insertably and removably mount the optical inspection units in cooperation with the probe card and allows to hold the optical inspection units, when mounted, with optical axes thereof being aligned on the light receiving surface of the image pickup devices. The mount mechanism 506 is formed of one or a plurality of supporting mounts having the through-holes 509 and 501a that support the optical inspection units 520 in a manner penetrating therethrough in principle.

The through-holes 501a and 509 form holding holes 515 that allow to hold the optical inspection units so as to be freely attachable and detachable. This makes it possible to individually insert and remove the respective optical inspection units 520 with respect to the holding holes 515, and by, for example, preparing a plurality of optical inspection units with different pupil distances corresponding to the sizes of solid-state image pickup devices to be subjects in advance, the pupil distance can be set by replacing only the optical inspection units according to a change in size of the solid-state image pickup devices being an inspection target. Here, a converting adjustment (pupil distance and angle of view adjustment) that is carried out for a light from the light irradiator corresponding to the image pickup devices being an inspection target so as to meet specifications of the image pickup devices is individually carried out for each of the optical inspection units. The individual adjustment means 505 includes a construction of the optical inspection units 520 made attachable and detachable with respect to the holding means 504.

As in the above, since the holding holes 515 including the through-holes 501a and 509 and the holes 512 are fixed in a centered condition so that center axes of penetration, that is, optical axes through which light passes are made coincident, when the optical inspection units 520 are inserted and mounted in the holding holes 515, while optical axes C of the optical inspection units 520 to be described later are aligned on light receiving surfaces 1A of the image pickup devices 1, the light emitting sides of the optical inspection units are arranged in opposition to light receiving portions of the image pickup devices so as to simultaneously align and hold the plurality of optical inspection units 520. In the above embodiment of the inspection apparatus for an image pickup device, the holding means 504 includes the mount mechanism 506.

The optical inspection units 520 are auxiliary light irradiators that are arranged in opposition to the light receiving portions of the image pickup devices 1 and irradiate test lights through the plurality of openings 501a of the probe card 501, and each one of the optical inspection units 520 is inserted into the holding holes 515 so as to irradiate a test light onto one corresponding image pickup device. As described above, in the present embodiment, the plurality of optical inspection units 520 are simultaneously positioned and held by the holding means, and the respective optical inspection units 520 are positioned and held so as to be attachable and detachable with respect to the holding holes 515. Concretely, in the present embodiment, by the 16 holding holes 515 formed in a lengthwise and widthwise matrix, the optical inspection units 520 are arrayed and held lengthwise and widthwise in a matrix, and a characteristic inspection of the plurality of solid-state image pickup devices that receive test lights after a pupil distance and angle of view adjustment irradiated from the respective optical inspection units is carried out in a short time.

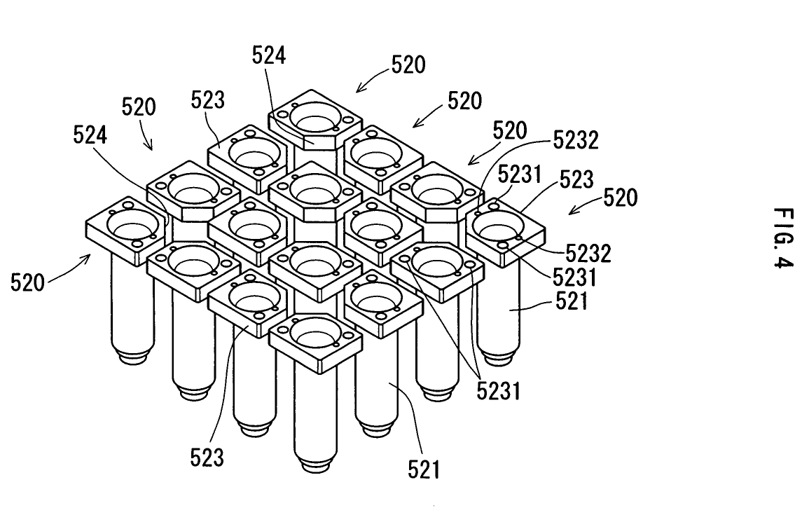

As shown in FIG. 3 through FIG. 5, the optical inspection unit 520 is formed of a case body made of a non-translucent member, and the case body is made attachable and detachable with respect to the holding member 504. In detail, the optical inspection unit 520 is formed of a barrel long in one direction, and the barrel is attached so as to be mountable and removable with respect to the holding hole 515 of the holding means 504. In greater detail, in the present embodiment, the optical inspection unit 520 includes a cylindrical member 521 made of a non-translucent resin whose both ends are opened and one or a plurality of optical lenses 522 incorporated into the cylindrical member. In the present embodiment, the cylindrical member 521 is constructed with a size of approximately 7 mm×30 mm in diameter×barrel length. A ratio of the diameter to the barrel length is preferably 1:1.3 to 1:2.7, for example. Since the optical inspection unit 520 is formed of a barrel long in one direction, a plurality of optical lenses 522 are arranged in line so that the optical axis penetrates thorough the lens surfaces thereof, whereby a spacing adjustment therefor can be easily carried out, and a large angle of view is secured so that execution of a pupil position adjustment for the individual units can be secured. In addition, by making each optical inspection unit be attachable and detachable with respect to the holding means, the degree of freedom in design and manufacturing of the optical inspection units is improved so that a high-precision pupil distance adjustment becomes possible, and even when another problem has occurred, the problem can be coped with by individually replacing by attaching and detaching the optical inspection units. On one end side of the cylindrical member 521, a flange portion 523 is integrally fixed, and while the cylindrical member 521 is inserted into the holding hole 515, a part protruded from the circumference of the flange portion 523 is latched with the upper plate portion 507A so that the entire cylindrical member is held by latching. With respect to the holding hole 515, the cylindrical member 521 is set so that a housing position in the hole can be accurately determined. For the flange portion 523 having a square plate form in the present embodiment, as shown in FIG. 2 and FIG. 4, one corner of the square is cut out so as to form a cutout portion 524, and via the cutout portions 524, a mounting and removing operation into and from the holding holes 515 can be stably carried out without difficulty when a plurality of adjacent units are inserted and removed with respect to the upper through-holes 509 and through-holes 501a of the probe card formed densely in a matrix. On the flange portion 523, fixing screw holes 5231 and guide pin insertion holes 5232 are respectively formed, and when each optical inspection unit is inserted into the holding hole 515, unillustrated guide pins provided so as to vertically protrude from the top of the upper plate portion 507A are inserted into the guide pin insertion holes 5232 so as to latch the flange portion 523 with the upper plate portion 507A. Then, by unillustrated fixing pins, the unit 520 is fixed from the upside via the fixing screw holes 523.

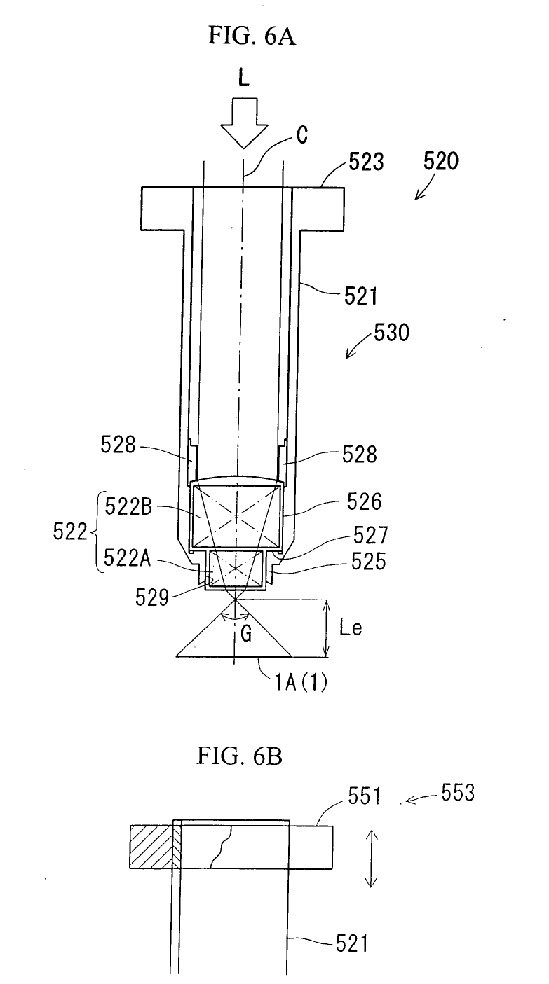

In FIG. 6A, as the optical lenses incorporated into the case body, a plurality of lenses are arranged according to the present embodiment. In the present embodiment, a plurality of optical lenses 522 are arranged in line so that the optical axis penetrates through the center of the lens surfaces, and in a mode of combination according to necessity, these are arranged so as to obtain a necessary pupil distance and angle of view. In the drawing, the cylindrical member 521 has a small-diameter lens housing portion 525 inside the lower end side and a large-diameter lens housing portion 526 thereon, and in the interior of these, unillustrated small-diameter and large-diameter lens groups 522A and 522B for which a plurality of lenses are arranged, respectively, are positioned and arranged in an accurately positioned condition. For example, the small-diameter lens housing portion 525 and the large-diameter lens housing portion 526 thereon are set so that lenses with different diametrical sizes are respectively arranged via a stepped portion 527 without looseness. A spacer 528 that holds large-diameter lenses housed in the large-diameter lens housing portion 526 by pressing from the upside is attached, whereby a plurality of lenses with different sizes are arranged in series while the optical axes are aligned, and light emitted from an opening 529 is irradiated onto the device light receiving surface 1A being an inspection target. At this time, an appropriate pupil distance Le corresponding to the pupil position of the device light receiving surface 1A being an imaging plane is set.

In the mode of FIG. 6A, the respective lenses are fixedly arranged in the cylindrical member 521. And, a plurality of types of optical inspection units 520 to obtain different pupil distances depending on a combination of the arrangement, number, size, and the like of lenses are prepared, and replacing by attaching and detaching these, for a light from a light illuminating device, a converting adjustment to match the same with specifications of the image pickup device is individually carried out.

The method for individually carrying out a converting adjustment, for a light from an illuminating device, to match the same with specifications of the image pickup device is not limited to the embodiment described above. For example, as the optical lens 521, only one lens may be provided. In addition, a single optical lens 522 may be fixedly attached in the cylindrical member 522, and it may be made shiftable in the interior thereof in a sliding condition or to a plurality of point positions in the optical axis direction and may be positioned at a necessary position. Moreover, as shown in FIG. 6B, it is possible to attach a movable latching member 551 provided by making a flange portion being a latching member movable to the cylindrical member 521 of the optical inspection unit, change the attaching position in the longitudinal direction (optical axis direction) of the movable latching member 551 to the cylindrical member 521, and hold the member in a coupled and fixed condition at the changed position, and the cylindrical member may be thereby set at a necessary pupil position. In this case, a mechanism that makes the movable latching member 551 shiftable in the longitudinal direction of the cylindrical member 521 and fixedly set the same at an arbitrary shifting position forms an engagement position shifting adjustment mechanism 553.

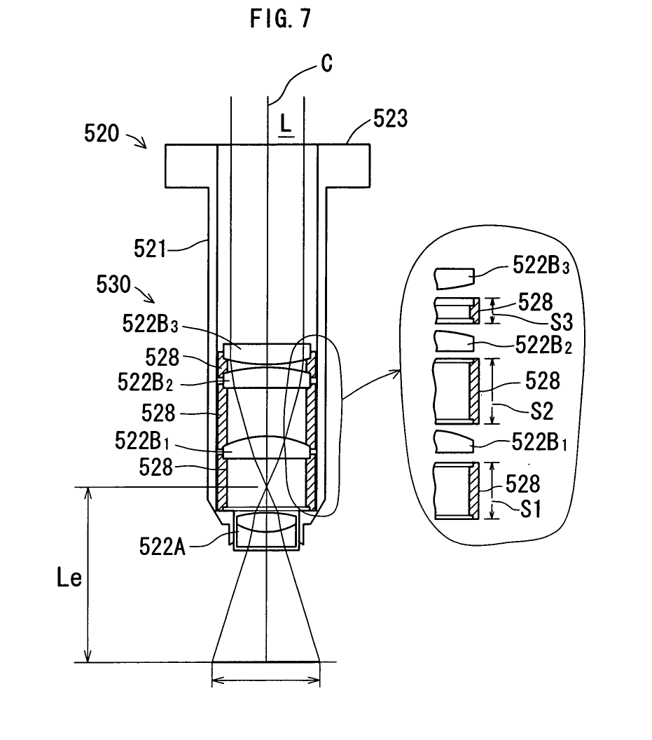

Moreover, as shown in FIG. 7, an axial position adjustment mechanism 530 that sets a plurality of lenses arranged in series inside the cylindrical member so that the optical-axis-direction position in the case body is changeable may be provided. In FIG. 7, the large-diameter lens group 522B arranged above the small-diameter lens group 522A includes three optical axis orthogonal lenses 522B1 to 522B3, and by the spacers 528, the respective lenses are determined in terms of isolated positions and arranged while being isolated from each other with different spacing S1, S2, and S3 to be set. The spacers 528 form the axial position adjustment mechanism 530 that sets a plurality of lenses arranged in series inside the cylindrical member so that the optical-axis-direction position in the case body is changeable. In the present embodiment, the spacers 528 are made of a plurality of rink-shaped spacers that have different heights and attachably and detachably fit in the cylindrical member, and by variously changing these spacers 528, a necessary pupil position setting can be carried out. As a combination mode of these, if spacers corresponding to necessary types and sizes of lenses are prepared in advance according to necessity, when the solid-state image pickup devices to be inspected change, a characteristic inspection of the next type of wafer can be carried out by merely replacing the optical inspection units 520. Therefore, not only can setup changing operation time, positioning time, and the like be greatly reduced, replacement in each inspection thereof for, for example, every probe card is unnecessary, and the inspection cost can also be greatly reduced. The axial position adjustment mechanism 530 is not limited to one by the above spacers 528. For example, a mechanism that moves lenses up and down while individually grasping the lenses can also be provided for positioning.

In FIGS. 1, 5, and 8, to the pin retainer plates 511 attached via the lower mount 510, the probe pins 502 are fixed with their front ends oriented to the side of the solid-state image pickup device 1 being an inspection target. In detail, in FIG. 5, the probe pins 502 are fixed so as to penetrate through the two retainer plates at pin retaining portions 513 of the end portions of the pin retainer plates 511, and pin end portions that contact with the solid-state image pickup device being an inspection target extend vertically to the device and touch the light receiving surface 1A of the light receiving portion. The probe pins 502 also vertically protrude from the pin retainer plates 511. Namely, the probe pins 502 are constructed as vertical pins so as to almost vertically abut against the light receiving surface 1A of the light receiving portion of the solid-state image pickup device. The probe pins 502 according to the present embodiment are made of high-strength conductive pin members. The pin retainer plates 511 are made of two ceramic plates coupled in a layer form with a parallel gap formed therebetween, and, the probe pins 502 are attached and fixed to the pin retainer plates 511. In a manner supported by the two isolated pin retainer plates 511 with a parallel gap formed therebetween, the probe pins 502 are vertically retained, and at this time, impact resistance when these abut against a pad portion of the solid-state image pickup device being an inspection target is reinforced.

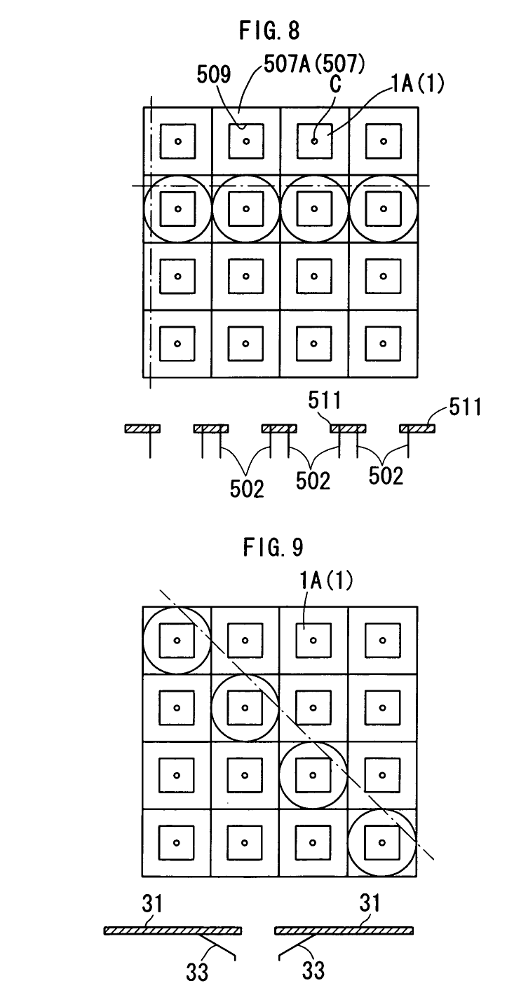

Moreover, in FIG. 5, a substantial optical path of the light L emitted from the opening 529 at the lower end of the cylindrical portion 521 has smaller width spacing than a size R of the solid-state image pickup device R, and in order to make it possible to obtain an angle of view G smaller than the size R, the opening 529 and optical-axis-direction position of the optical lens 522 in the cylindrical member can be set. Accordingly, even in a condition where a plurality of optical inspection units 520 are simultaneously held lengthwise and widthwise in a matrix by the holding means 504, probe pin spacing at the time of inspection corresponding to chip spacing of the wafer can be secured. This allows, for example, to shift the stage 142 of the prober while continuing to hold the 16 optical inspection units in a matrix as in FIG. 4 and simultaneously inspect the inspection subjects adjacent in the vertical or horizontal direction as shown by a broken line in FIG. 8. Accordingly, as many as 8 or 16 optical inspection units can be simultaneously inspected according to testability of the tester 16. As in FIG. 9, conventionally, with an inverted V-shaped supporting structure of probe pins 33 attached to a probe card 31, inspection could have been carried out only in order of inspection to shift in the oblique direction along a virtual line of FIG. 9 in a manner corresponding to chip spacing of the wafer. In comparison with this case, control at the side of the stage for wafer shifting is simple, and inspection time can also be greatly reduced.

As in the above, the optical inspection unit device by the mount mechanism simultaneously holds a plurality of optical inspection units at holding positions in a lengthwise and widthwise matrix coincident with a formation spacing of the image pickup devices installed in a matrix, therefore, advantageous effects as described above are obtained.

Next, operations of an optical inspection unit device according to the embodiment of the present invention will be described. The optical inspection units 520 are inserted through the upper through-holes 509 of the supporting mount 507 being a holding means, which have been aligned with the through-holes 501a of the probe card, respectively. Then, the 16 optical inspection units 520 are inserted through the 16 holding holes 515 and are fixed while being positioned by the unillustrated guide pins and fixing pins. Then, the stage 142 on whose upper surface the wafer W with solid-state image pickup devices formed is placed is shifted in the X, Y, Z, and θ directions and is transfer-positioned. In FIG. 5, in a condition where the light receiving surface 1A of the solid-state image pickup device 1 being an inspection target has risen and the probe pins 502 has abut against the pad portion of the device, the solid-state image pickup device is made to electrically contact with the tester 16, and a predetermined photoelectric conversion characteristic test is carried out.

Then, a characteristic test is simultaneously carried our for, for example, 16 solid-state image pickup devices, and after the characteristic test has ended for a block of these devices, the stage 142 of the prober 14 is shifted in the vertical or horizontal direction, and a similar inspection is carried out for a next block of solid-state image pickup devices.

With regard to the size of solid-state image pickup devices as an inspection target, if devices of a different size are inspected, the fixing pins at the flange portions of the optical inspection units 520 are removed and the respective optical inspection units 520 are extracted from the holding holes 515. Then, optical inspection units 520 with a lens structure corresponding to the pupil position of the solid-state image pickup devices being a new inspection target are fitted by insertion into the respective holding holes 515 and are screw-fixed at their flange portions, and a characteristic test is then carried out by a similar method to the above.

The optical inspection unit 520 with a lens structure corresponding to the pupil position of the solid-state image pickup devices being a new inspection target can be dealt with, without replacing the cylindrical members themselves, by merely changing and adjusting the internal lens structure, as long as these are of a configuration that can change, for each individual cylindrical member 521, the setting of the internal optical lens size, focal position, and lens spacing by use of an axial position adjustment mechanism, for example, a spacer members 528 or the like.

Moreover, as shown in FIG. 6B, the movable flange portion being a latching member may be shifted so as to change the attaching position in the longitudinal direction (optical axis direction) of the flange portion to the cylindrical member, and the cylindrical member may be thereby set at a necessary pupil position and used.

The construction of the optical inspection unit device and inspection apparatus for an image pickup device described in the above is not limited to that of the above-described embodiment, and any changes and modifications may be made therein without departing from the spirit of the invention set forth in the claims. For example, the outward form of the probe card and supporting mount is not limited to a circular form and may be a square form or another polygonal form. Moreover, the form of the respective holes 509 and 501a or the cylindrical member of the optical inspection unit body may also be a polygonal form in a cross section. Moreover, the number of holding holes of the holding means 504 is not limited to 16 lengthwise and widthwise, and a perforated construction with a greater or smaller number of holes that allows to simultaneously inspect solid-state image pickup devices with any matrix arrangement can be employed.

The optical inspection unit device, optical inspection unit, and optical inspection apparatus for an image pickup device of the present invention can be applied to a photoelectric conversion characteristic inspection of a solid-state image pickup device such as a CCD and a CMOS.

The optical inspection unit device according to the present invention is an optical inspection unit device that irradiates a test light, in a photoelectric conversion characteristic inspection of an image pickup device, while being arranged in opposition to a light receiving portion of the image pickup device and includes: a probe card that retains a probe pin to take out output from an output terminal portion of an image pickup device and is equipped with a plurality of openings that transmit light to the image pickup device; an optical inspection unit that emits the test light through the plurality of openings of the probe card while being arranged in opposition to the light receiving portion of the image pickup device; a holding means that simultaneously positions and holds a plurality of optical inspection units while arranging an emission side of the optical inspection unit in opposition to the light receiving portion of the image pickup device with an optical axis of the optical inspection unit being aligned on the light receiving surface of the image pickup device; and an individual adjustment means that makes a converting adjustment carried out, for light from a light irradiator corresponding to the image pickup device being an inspection target, so as to match the same with specifications of the image pickup device be individually carried out for each optical inspection unit. Thereby, even when an inspection is carried out for solid-state image pickup devices being an inspection target that are different in size, for the same inspection apparatus, without basically changing the probe card and holding means, as a result of coping therewith merely by a change in type and specifications of only the optical inspection units and a position adjustment, and the like, alignment between the optical inspection units and probe card can be simply carried out in a short time, the configuration of the holding portion of the optical inspection units is reduced in size, and moreover, it is possible to carry out an efficient and consecutive characteristic inspection. In addition, reduction in manufacturing cost of the inspection instruments, reduction in inspection preparation time, maintainability, and the like can be secured.

The optical inspection unit is formed of a case body having a built-in optical lens, and the individual adjustment means makes the case body attachable and detachable with respect to the holding means. Therefore, a plurality of types of optical inspection units having a predetermined pupil distance setting function are prepared in advance, and when an inspection for other solid-state image pickup devices different in size, angle of view, and pupil distance is necessary as a result of a change in the inspection target, an inspection corresponding thereto can be executed by only an attaching and detaching replacing operation.

In addition, for the individual adjustment means, a shifting adjustment mechanism for an engagement position between the optical inspection unit and holding means is provided so as to make the whole optical inspection unit shiftable in an optical axis direction, and the converting adjustment to match light from a light irradiator with specifications of the image pickup device is carried out by a shifting adjustment of the engagement position by the shifting adjustment mechanism. Thereby, a photoelectric conversion characteristic inspection of new solid-state image pickup devices different in chip size for which the inspection target has been renewed can be continuously carried out by only a shifting adjustment of the engagement position between the optical inspection units and holding means. In addition, by providing the axial position adjustment mechanism that sets an optical-axis-direction position of the plurality of optical lenses in the case body so as to be changeable, a characteristic inspection of new solid-state image pickup devices can be carried out by only an attaching position adjustment of the lenses in the case body and a size adjustment. In addition, when the optical inspection unit is formed of a barrel long in one direction, the angle of view range of light after emission can be greatly secured, and the pupil distance setting range or the correction range of the pupil distance can be greatly secured. Furthermore, the probe pin is formed of a vertical pin that almost vertically abuts against the light receiving portion of the image pickup device. Thereby, even in a condition where the optical inspection units are simultaneously held, a probe pin spacing at the time of inspection corresponding to a chip spacing of the wafer can be secured, and thereby, the stage of the prober can be shifted while remaining in a condition where, for example, 16 optical inspection units are held in a matrix, so that the inspection subjects that are adjacent in a vertical or horizontal direction can be simultaneously inspected. Furthermore, not only can inspection time also be greatly reduced, but also drive control of the shifting stage side being a transfer side of the wafer is simplified.

In addition, the optical inspection unit according to the present invention is the same in construction as the optical inspection units of the above-described optical inspection unit device, and operations and effects the same as the above can be provided.

Furthermore, also in the inspection apparatus for an image pickup device according to the present invention, by including an optical inspection unit device being a characteristic construction of the invention as claimed in the present application or optical inspection units thereof, inspection time for the whole inspection apparatus can be greatly reduced, operational setup changing time can be reduced, operation efficiency can be improved, and furthermore, maintainability can be satisfactorily held. At the same time, this contributes to a reduction in inspection cost.

What is claimed is:

1. An optical inspection unit device that irradiates a test light, in a photoelectric conversion characteristic inspection of an image pickup device, while being arranged in opposition to a light receiving portion of the image pickup device, comprising:
a probe card that retains a probe pin to take out output from an output terminal portion of an image pickup device and is equipped with a plurality of openings that transmit light to the image pickup device;
an optical inspection unit that emits the test light through the plurality of openings of the probe card while being arranged in opposition to the light receiving portion of the image pickup device;
a holding means that simultaneously positions and holds a plurality of optical inspection units while arranging an emission side of the optical inspection unit in opposition to the light receiving portion of the image pickup device with an optical axis of the optical inspection unit being aligned on the light receiving surface of the image pickup device; and
an individual adjustment means that makes a converting adjustment carried out, for light from a light irradiator corresponding to the image pickup device being an inspection target, so as to match the same with specifications of the image pickup device be individually carried out for each optical inspection unit.

2. The optical inspection unit device according to claim 1, wherein
the optical inspection unit is formed of a case body having a built-in optical lens, and
the individual adjustment means makes the case body attachable and detachable with respect to the holding means.

3. The optical inspection unit device according to claim 1, wherein
the individual adjustment means includes a shifting adjustment mechanism for an engagement position between the optical inspection unit and holding means so as to make the whole optical inspection unit shiftable in an optical axis direction, and
the converting adjustment to match light from a light irradiator with specifications of the image pickup device is carried out by a shifting adjustment of the engagement position by the shifting adjustment mechanism.

4. The optical inspection unit device according to claim 2, wherein
the individual adjustment means includes a shifting adjustment mechanism for an engagement position between the optical inspection unit and holding means so as to make the whole optical inspection unit shiftable in an optical axis direction, and
the converting adjustment to match light from a light irradiator with specifications of the image pickup device is carried out by a shifting adjustment of the engagement position by the shifting adjustment mechanism.

5. The optical inspection unit device according to claim 4, wherein
the case body has a plurality of built-in optical lenses, and
the individual adjustment means includes an axial position adjustment mechanism that sets an optical-axis-direction position of the plurality of optical lenses in the case body so as to be changeable.

6. The optical inspection unit device according to claim 2, wherein the optical inspection unit is formed of a barrel long in one direction.

7. The optical inspection unit device according to claim 4, wherein the optical inspection unit is formed of a barrel long in one direction.

8. The optical inspection unit device according to claim 4, wherein the holding means is formed of a mount mechanism that allows to insertably and removably mount the optical inspection unit in cooperation with the probe card and allows to hold the optical inspection unit, when mounted, with an optical axis thereof being aligned on the light receiving surface of the image pickup device.

9. The optical inspection unit device according to claim 6, wherein the holding means is formed of a mount mechanism that allows to insertably and removably mount the optical inspection unit in cooperation with the probe card and allows to hold the optical inspection unit, when mounted, with an optical axis thereof being aligned on the light receiving surface of the image pickup device.

10. The optical inspection unit device according to claim 9, wherein the mount mechanism is formed of one or a plurality of supporting mounts having a through-hole that supports the optical inspection unit in a manner penetrating therethrough.

11. The optical inspection unit device according to claim 1, wherein the probe pin is formed of a vertical pin that almost vertically abuts against the light receiving portion of the image pickup device.

12. The optical inspection unit device according to claim 6, wherein the probe pin is formed of a vertical pin that almost vertically abuts against the light receiving portion of the image pickup device.

13. The optical inspection unit device according to claim 7, wherein the probe pin is formed of a vertical pin that almost vertically abuts against the light receiving portion of the image pickup device.

14. The optical inspection unit device according to claim 8, wherein the probe pin is formed of a vertical pin that almost vertically abuts against the light receiving portion of the image pickup device.

15. The optical inspection unit device according to claim 9, wherein the probe pin is formed of a vertical pin that almost vertically abuts against the light receiving portion of the image pickup device.

16. The optical inspection unit device according to claim 10, wherein the probe pin is formed of a vertical pin that almost vertically abuts against the light receiving portion of the image pickup device.

17. The optical inspection unit device according to claim 10, wherein the optical inspection unit device by the mount mechanism simultaneously holds a plurality of optical inspection units at holding positions in a lengthwise and widthwise matrix coincident with a formation spacing of the image pickup devices installed in a matrix.

18. The optical inspection unit device according to claim 11, wherein the optical inspection unit device by the mount mechanism simultaneously holds a plurality of optical inspection units at holding positions in a lengthwise and widthwise matrix coincident with a formation spacing of the image pickup devices installed in a matrix.

19. The optical inspection unit device according to claim 12, wherein the optical inspection unit device by the mount mechanism simultaneously holds a plurality of optical inspection units at holding positions in a lengthwise and widthwise matrix coincident with a formation spacing of the image pickup devices installed in a matrix.

20. The optical inspection unit device according to claim 13, wherein the optical inspection unit device by the mount mechanism simultaneously holds a plurality of optical inspection units at holding positions in a lengthwise and widthwise matrix coincident with a formation spacing of the image pickup devices installed in a matrix.

21. The optical inspection unit device according to claim 14, wherein the optical inspection unit device by the mount mechanism simultaneously holds a plurality of optical inspection units at holding positions in a lengthwise and widthwise matrix coincident with a formation spacing of the image pickup devices installed in a matrix.

22. The optical inspection unit device according to claim 15, wherein the optical inspection unit device by the mount mechanism simultaneously holds a plurality of optical inspection units at holding positions in a lengthwise and widthwise matrix coincident with a formation spacing of the image pickup devices installed in a matrix.

23. The optical inspection unit device according to claim 16, wherein the optical inspection unit device by the mount mechanism simultaneously holds a plurality of optical inspection units at holding positions in a lengthwise and widthwise matrix coincident with a formation spacing of the image pickup devices installed in a matrix.

24. An optical inspection unit that irradiates a test light, in a photoelectric conversion characteristic inspection of an image pickup device, while being arranged in opposition to a light receiving portion of the image pickup device, wherein
the optical inspection unit is attachably and detachably held by a holding means installed in the vicinity of a probe card having a plurality of openings, is held, when mounted, with an optical axis thereof being aligned on a light receiving surface of the image pickup device, and
furthermore, carries out, by means of an individual adjustment means, a converting adjustment to match light from a light irradiator corresponding to the image pickup device being an inspection target with specifications of the image pickup device for each optical inspection unit individually.

25. The optical inspection unit according to claim 24, wherein the optical inspection unit is formed of a case body having a built-in optical lens, and
the case body is made attachable and detachable with respect to the holding means.

26. The optical inspection unit according to claim 24, wherein the whole optical inspection unit is held by the holding means while being made shiftable in an optical axis direction.

27. The optical inspection unit according to claim 25, wherein
the case body has a plurality of built-in optical lenses, and
an axial position adjustment mechanism that sets an optical-axis-direction position of the plurality of optical lenses in the case body so as to be changeable is included.

28. The optical inspection unit according to claim 26, wherein the optical inspection unit is formed of a barrel long in one direction.

29. The optical inspection unit according to claim 27, wherein the optical inspection unit is formed of a barrel long in one direction.

30. An inspection apparatus for an image pickup device that irradiates a test light onto an image pickup device to inspect photoelectric conversion characteristics of the image pickup device, having an optical inspection unit device that irradiates a test light while being arranged in opposition to a light receiving portion of the image pickup device, the optical inspection unit device comprising:
a probe card that retains a probe pin to take out output from an output terminal portion of an image pickup device and is equipped with a plurality of openings that transmit light to the image pickup device;
an optical inspection unit that emits the test light through the plurality of openings of the probe card while being arranged in opposition to the light receiving portion of the image pickup device;
a holding means that simultaneously positions and holds a plurality of optical inspection units while arranging an emission side of the optical inspection unit in opposition to the light receiving portion of the image pickup device with an optical axis of the optical inspection unit being aligned on the light receiving surface of the image pickup device; and
an individual adjustment means that makes a converting adjustment carried out, for light from a light irradiator corresponding to the image pickup device being an inspection target, so as to match the same with specifications of the image pickup device be individually carried out for each optical inspection unit.

31. The inspection apparatus for an image pickup device according to claim 30, wherein
the optical inspection unit is formed of a case body having a built-in optical lens, and
the individual adjustment means makes the case body attachable and detachable with respect to the holding means.

32. The inspection apparatus for an image pickup device according to claim 30, wherein
the individual adjustment means includes a shifting adjustment mechanism for an engagement position between the optical inspection unit and holding means so as to make the whole optical inspection unit shiftable in an optical axis direction, and
the converting adjustment to match light from a light irradiator with specifications of the image pickup device is carried out by a shifting adjustment of the engagement position by the shifting adjustment mechanism.

33. The inspection apparatus for an image pickup device according to claim 31, wherein
the individual adjustment means includes a shifting adjustment mechanism for an engagement position between the optical inspection unit and holding means so as to make the whole optical inspection unit shiftable in an optical axis direction, and
the converting adjustment to match light from a light irradiator with specifications of the image pickup device is carried out by a shifting adjustment of the engagement position by the shifting adjustment mechanism.

34. The inspection apparatus for an image pickup device according to claim 33, wherein
the case body has a plurality of built-in optical lenses, and
the individual adjustment means includes an axial position adjustment mechanism that sets an optical-axis-direction position of the plurality of optical lenses so as to be changeable.

35. The inspection apparatus for an image pickup device according to claim 31, wherein the optical inspection unit is formed of a barrel long in one direction.

36. The inspection apparatus for an image pickup device according to claim 33, wherein the optical inspection unit is formed of a barrel long in one direction.

37. The inspection apparatus for an image pickup device according to claim 33, wherein the holding means is formed of a mount mechanism that allows to insertably and removably mount the optical inspection unit while being coupled with the probe card and allows to hold the optical inspection unit, when mounted, with an optical axis thereof being aligned on the light receiving surface of the image pickup device.

38. The inspection apparatus for an image pickup device according to claim 34, wherein the holding means is formed of a mount mechanism that allows to insertably and removably mount the optical inspection unit while being coupled with the probe card and allows to hold the optical inspection unit, when mounted, with an optical axis thereof being aligned on the light receiving surface of the image pickup device.

39. The inspection apparatus for an image pickup device according to claim 35, wherein the holding means is formed of a mount mechanism that allows to insertably and removably mount the optical inspection unit while being coupled with the probe card and allows to hold the optical inspection unit, when mounted, with an optical axis thereof being aligned on the light receiving surface of the image pickup device.

40. The inspection apparatus for an image pickup device according to claim 37, wherein the mount mechanism is formed of one or a plurality of supporting mounts having a through-hole that supports the optical inspection unit in a manner penetrating therethrough.

41. The inspection apparatus for an image pickup device according to claim 30, wherein the probe pin is formed of a vertical pin that almost vertically abuts against the light receiving portion of the image pickup device.

42. The inspection apparatus for an image pickup device according to claim 35, wherein the probe pin is formed of a vertical pin that almost vertically abuts against the light receiving portion of the image pickup device.

43. The inspection apparatus for an image pickup device according to claim 36, wherein the probe pin is formed of a vertical pin that almost vertically abuts against the light receiving portion of the image pickup device.

44. The inspection apparatus for an image pickup device according to claim 40, wherein the probe pin is formed of a vertical pin that almost vertically abuts against the light receiving portion of the image pickup device.

45. The inspection apparatus for an image pickup device according to claim 39, wherein the optical inspection unit simultaneously holds a plurality of optical inspection units at holding positions by the mount mechanism in a lengthwise and widthwise matrix coincident with a formation spacing of the image pickup devices installed in a matrix.

46. The inspection apparatus for an image pickup device according to claim 40, wherein the optical inspection unit simultaneously holds a plurality of optical inspection units at holding positions by the mount mechanism in a lengthwise and widthwise matrix coincident with a formation spacing of the image pickup devices installed in a matrix.

47. The inspection apparatus for an image pickup device according to claim 41, wherein the optical inspection unit simultaneously holds a plurality of optical inspection units at holding positions by the mount mechanism in a lengthwise and widthwise matrix coincident with a formation spacing of the image pickup devices installed in a matrix.

48. The inspection apparatus for an image pickup device according to claim 42, wherein the optical inspection unit simultaneously holds a plurality of optical inspection units at holding positions by the mount mechanism in a lengthwise and widthwise matrix coincident with a formation spacing of the image pickup devices installed in a matrix.

49. The inspection apparatus for an image pickup device according to claim 43, wherein the optical inspection unit simultaneously holds a plurality of optical inspection units at holding positions by the mount mechanism in a lengthwise and widthwise matrix coincident with a formation spacing of the image pickup devices installed in a matrix.

50. The inspection apparatus for an image pickup device according to claim 44, wherein the optical inspection unit simultaneously holds a plurality of optical inspection units at holding positions by the mount mechanism in a lengthwise and widthwise matrix coincident with a formation spacing of the image pickup devices installed in a matrix.
